(19) United States
(12) Patent Application Publication
(10) Pub. No.: US 2008/0023283 A1
(43) Pub. Date: Jan. 31, 2008

(54) Portable workstation

(76) Inventors: Ian Sutker, Springfield, IL (US); John Skarlis, Cedar Falls, IA (US); Eliot Evans, Joice, IA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/879,222

(22) Filed: Jul. 16, 2007

Related U.S. Application Data
(60) Provisional application No. 60/830,930, filed on Jul. 14, 2006.

(51) Int. Cl. G06F 1/16; A45C 3/00

(52) U.S. Cl. 190/100; 361/683

(57) ABSTRACT

A portable workstation and related methods of using a portable workstation in a vehicle or similar remote location. The portable workstation includes a protective case enclosing a peripheral mounting frame. The peripheral mounting frame includes a mounting sheet, a vertical support member and a peripheral support assembly. The peripheral support assembly includes a pivoting base assembly attached to a rotatable arm assembly. The pivoting base assembly has a first mounting sheet for positioning a first peripheral device. The pivoting base assembly and rotatable arm assembly provide at least three degrees of freedom for orienting the first peripheral device. An accessory support sheet is rotatably mounted to the first mounting sheet such that an accessory device can be utilized with the first peripheral device. The portable workstation can include a second peripheral support assembly for mounting a second peripheral device. The base portion can include telescoping legs providing a self-supporting workstation.

### PRIORITY CLAIM

The present application claims priority to U.S. Provisional Application Ser. No. 60/830,930, filed Jul. 14, 2006, and entitled “PORTABLE WORKSTATION”, which is herein incorporated by reference in its entirety.

### FIELD OF THE INVENTION

The present invention relates generally to a portable workstation. More particularly, the invention relates to a portable workstation and related methods of use for providing a user with a convenient, ready to use workstation in a variety of remote locations.

### BACKGROUND OF THE INVENTION

Some industries or professions by their very nature require employees or other individuals to spend large amounts of time at off-site locales or traveling to meet with clients. Representative professions can include, for example, service providers such as landscapers, lawn maintenance and utility installers, building and real estate professionals such as realtors, contractors and architects and sales professionals including capital equipment sales, pharmaceutical sales and the like. Each one of these situations provides an opportunity for use of a portable office. These professional also typically utilize vehicles such as, for example, vans, cars, trucks, and the like are often utilized as a rolling office to carry equipment, tools, samples, products, and other such necessities for the job.

In many of these instances, access to a computer and/or printer is often desired to instantly provide employees or customers with bills, invoices, receipts, instructions, figures, drawings, pictures, product and/or service information, and other such printed materials, while reducing or eliminating the need for various trips between the office or store and the site. In addition, access to a computer and/or printer also reduces the occurrence of lost or forgotten materials. Furthermore, convenient access to a computer and printer can be especially advantageous in locations where phone and/or internet access is not generally available.

By way of background and example, U.S. Pat. Nos. 6,362,954 and 5,764,475 disclose a carrying case for a mobile office system designed to house both a computer and a printer. In addition, a power source is provided within the case. However, the computer and printer are located adjacent to one another with limited arrangement opportunities, creating a wide carrying case and ergonomically-limited working conditions when used in a vehicle.

U.S. Pat. No. 5,212,628 discloses a portable workstation comprising a movable computer support tray and a printer tray attached to the bottom of a carrying case. The computer support tray and printer tray are interconnected by a pair of arms. The computer support tray is adapted to be advanced relative to the printer. The computer, printer, and other peripherals are powered by a lead-acid battery stored within the carrying case. However, the computer tray's configuration is limited to advancing the computer in front and above the printer, therefore limiting its use to one configuration. In addition, because of the battery power source, the use of the portable workstation is limited to the life of the battery, requiring frequent recharging.

Notwithstanding the teachings of the above-noted patents and published applications, there remains a need for an improved workstation comprising a computer and printer for use in a vehicle.

### SUMMARY OF THE INVENTION

The present invention is directed to a portable workstation including a protective case and a peripheral mounting frame adapted to provide a portable workstation, such as for use in a vehicle or similar remote location. The peripheral mounting frame is generally mounted within a base portion of protective case. The peripheral mounting frame can comprise a mounting sheet, a vertical support member and a peripheral support assembly. The peripheral support assembly generally comprises a pivoting base assembly attached to a rotatable arm assembly. The pivoting base assembly can comprise a first mounting sheet for positioning a first peripheral device. The pivoting base assembly and rotatable arm assembly provide at least three degrees of freedom for orienting the position of the first peripheral device. An accessory support sheet can be rotatably mounted to the first mounting sheet such that an accessory device can be utilized with the first peripheral device. In some embodiments, the portable workstation can comprise a second peripheral support assembly for mounting a second peripheral device. In some embodiments, the base portion can comprise a plurality of telescoping legs allowing the portable workstation to be self-supporting. The portable workstation can further comprise a printer mounted directly to the peripheral mounting frame. Wiring association with power and communications can be maintained and retained with a cable management assembly operably attached to the peripheral mounting frame.

In one aspect, the present disclosure is directed to a portable workstation. The portable workstation can comprise a protective case and a peripheral mounting frame. The peripheral mounting frame is generally attached to the base portion of the protective case. In some embodiments, the protective case satisfies TSA and individual airline requirements for carry-on luggage. The peripheral mounting frame can comprise a mounting sheet, a vertical support member and at least one peripheral support assembly. A first peripheral support assembly can comprises a pivoting base assembly attached to a rotatable arm assembly. The pivoting base assembly can comprise a first mounting sheet for positioning a first peripheral device. The pivoting base assembly and rotatable arm assembly of the first peripheral support assembly provide at least three degrees of freedom for orienting the position of the first peripheral device. An accessory support sheet can be rotatably mounted to the first mounting sheet such that an accessory device can be utilized with the first peripheral device. In some embodiments, the portable workstation can comprise a second peripheral support assembly for mounting a second peripheral device. In some embodiments, the base portion can comprise a plurality of telescoping legs allowing the portable workstation to be self-supporting. The portable workstation can further comprise a printer mounted directly to the peripheral mounting frame. Wiring association with power and communications can be maintained and retained with a cable management assembly operably attached to the peripheral mounting frame.

In another aspect, the present disclosure is directed to a method of using a portable workstation. The method can comprise providing a protective container having a mounting frame attached within. A printer can then be attached to the mounting frame. A first peripheral support assembly having a rotating arm assembly and a pivoting mounting surface can be attached to the mounting frame. A laptop computer can be positioned on the pivoting mounting surface. The rotatable arm assembly and pivoting mounting surface through three degrees of freedom such that the laptop computer is positioned for use. The method can further comprise maintaining operable interconnection of the laptop computer and printer with a cable management assembly. The method can further comprise coupling a second peripheral support assembly to the mounting frame, the second peripheral support assembly having a second mounting surface for receiving a digital projector. The method can further comprise extending a plurality of projecting legs from a bottom surface of the protective carrier so as to selectively adjust the height of the protective carrier. The method can further comprise positioning at least one accessory support surface attached to the pivoting mounting surface such that an accessory device can be utilized with the laptop computer. The method can further comprise transporting the protective carrier in a closed configuration with the laptop computer and printer operably connected. The method can further comprise placing the protective carrier arranged in the closed configuration within an overhead bin on an airplane.

In yet another aspect, the present disclosure is directed to a portable workstation system. The portable workstation system can comprise a protective case and a peripheral mounting frame mounted within. The peripheral mounting frame can include support assemblies for a variety of peripheral devices including a printer, laptop computer, digital projector, computer mouse and the like. A first peripheral support assembly can allow the laptop computer to be pivoted and rotated about three axis of travel so as to orient the laptop computer into a convenient position for use. The portable workstation system is preferably sized and configured to allow for positioning in an overhead compartment in an airplane.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a perspective view of a portable workstation according to an embodiment of the present invention.

FIG. 2 is a perspective view of the portable workstation of FIG. 1.

FIG. 3 is a plan view of the portable workstation of FIG. 1.

FIG. 4 is side view of the portable workstation of FIG. 1.

FIG. 5 is a perspective view of a mounting sheet according to an embodiment of the present invention.

FIG. 6 is a side view of the mounting sheet of FIG. 5.

FIG. 7 is a plan view of the mounting sheet of FIG. 5.

FIG. 8 is a perspective view of vertical support member according to an embodiment of the present invention.

FIG. 9 is a side view of the vertical support member of FIG. 8.

FIG. 10 is a side view of a rotatable arm assembly according to an embodiment of the present invention.

FIG. 11 is side view of the rotatable arm assembly of FIG. 11.

FIG. 12 is a perspective view of a pivoting base assembly according to an embodiment of the present invention.

FIG. 13 is a side view of the pivoting base assembly of FIG. 12.

FIG. 14 is a bottom view of a first support sheet according to an embodiment of the present invention.

FIG. 15 is a front view of the first support sheet of FIG. 14.

FIG. 16 is a bottom, perspective view of the first support sheet of FIG. 14.

FIG. 17 is a plan view of a second support sheet according to an embodiment of the present invention.

FIG. 18 is a perspective view of the second support sheet of FIG. 17.

FIG. 19 is a side view of the second support sheet of FIG. 17.

FIG. 20 is a perspective view of an embodiment of a portable workstation according to an embodiment of the present invention.

FIG. 21 is a perspective view of an embodiment of a portable workstation according to an embodiment of the present invention.

FIG. 22 is a perspective view of the portable workstation of FIG. 21.

FIG. 23a is a perspective view of an embodiment of a mounting frame according to the present invention.

FIG. 23b is a section view of the mounting frame of FIG. 23a taken at line 23b-23b of FIG. 23a.

FIG. 24 is a side view of an embodiment of a slidable support sheet according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

In the following detailed description of the present invention, numerous specific details are set forth in order to provide a thorough understanding of the present invention. However, it will be obvious to one skilled in the art that the present invention can be practiced without these specific details. In other instances, well-known methods, procedures, and components have not been described in detail so as to not to unnecessarily obscure aspects of the present invention.

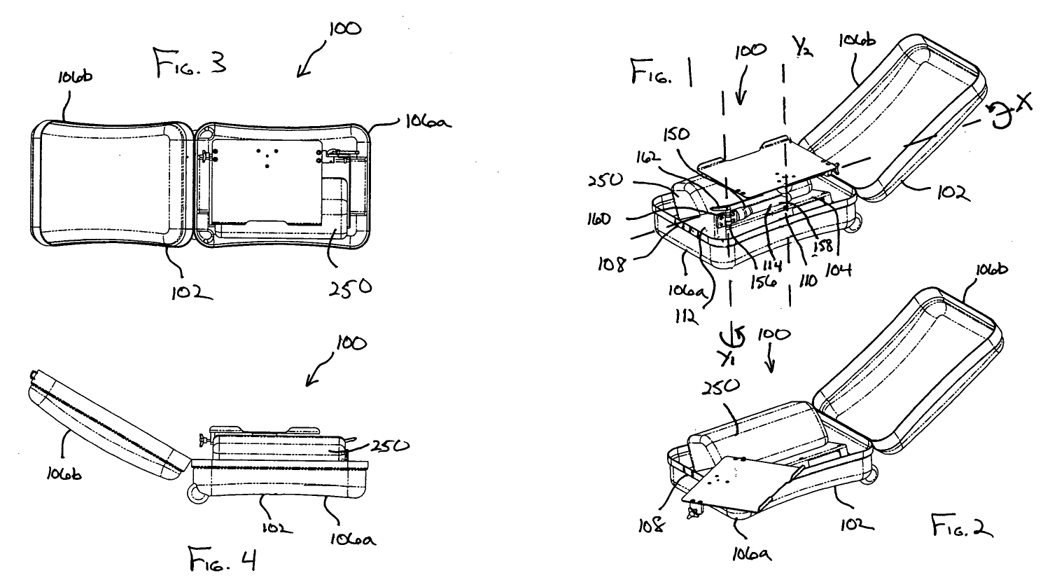

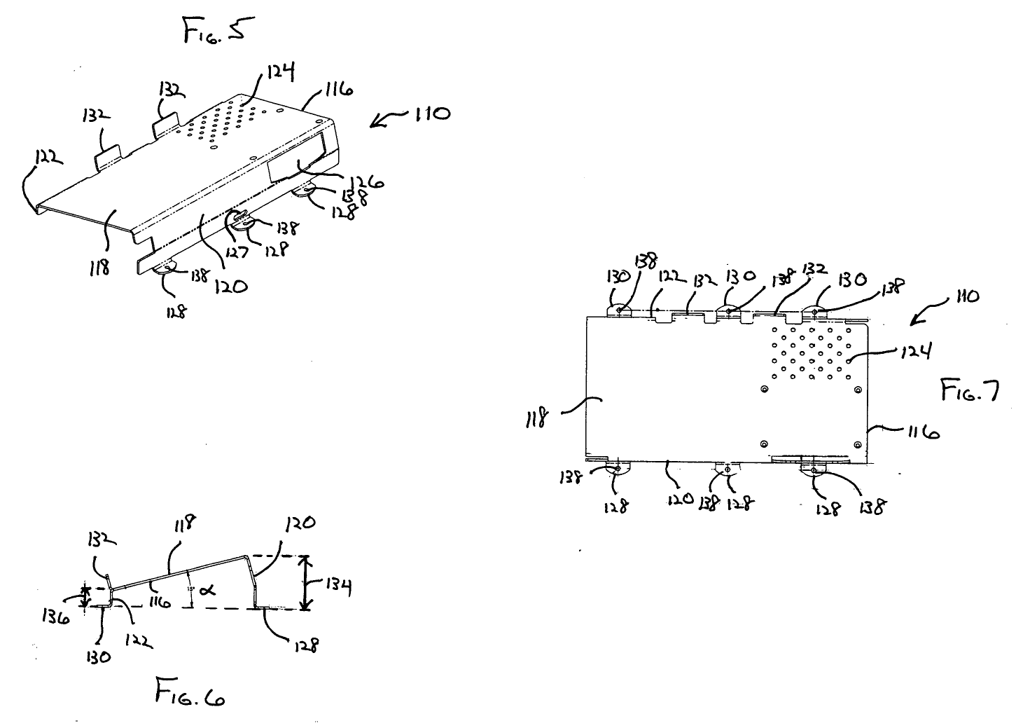

A representative embodiment of a portable workstation 100 is illustrated in FIGS. 1, 2, 3 and 4. Generally, portable workstation 100 generally can comprise a protective case 102 and a peripheral mounting frame 104. Protective case 102 can comprise any commercially available or custom-made suitcase, briefcase, and the like suitable for enclosing, containing and protecting various components of the portable workstation 100 as described below. Preferably, protective case 102 comprises a rolling style case to promote portability and ease of use. Generally, protective case 102 can include a base portion 106a and a lid portion 106b that are closable utilizing a conventional closure assembly 108 such as, for example, a zipper assembly, a latch assembly, a buckle assembly and the like. In some embodiments, base portion 106a and lid portion 106b can be removably connected with a detachable hinge assembly such that the lid portion 106b can be completely removed from the base portion 106a. In one representative embodiment, protective case 102 can be constructed and sized so as to meet Federal Aviation Administration Guidelines for carry on baggage as promulgated in Title 14 of the US Code of Federal Regulations (Aeronautics and Space PART 121—OPERATING REQUIREMENTS: DOMESTIC, FLAG, AND SUPPLEMENTAL OPERATIONS Subpart T—Flight Operations §121.589 Carry-on baggage). Protective case 102 can further comprise receptacles, pockets, and the like for storing items including, for example, printer paper, folders, documents, a cell phone, a PDA, a scanner, pens and pencils, an antenna, a modem, and the like.

Peripheral mounting frame 104 generally comprises a mounting sheet 110, a vertical support member 112 and a peripheral support assembly 114. The various components of the peripheral mounting frame 104 are generally constructed of rigid, lightweight materials such as, for example, aluminum, suitable metallic alloys and the like. In some instances, non-weight bearing components can be fabricated of suitable polymers to further assist in overall weight reduction of portable workstation 100.

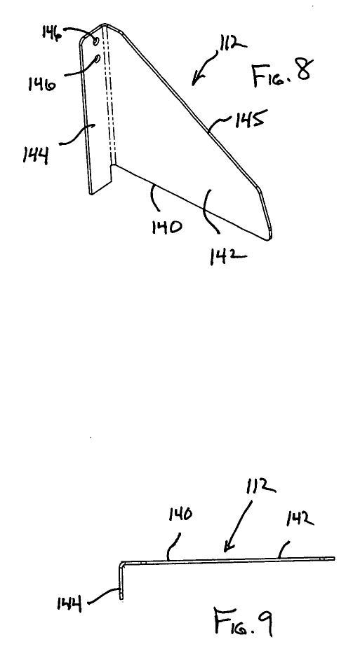

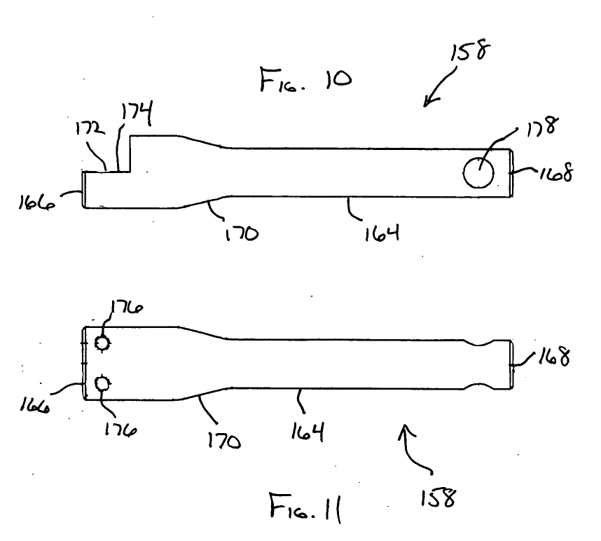

Referring to FIGS. 5, 6 and 7, mounting sheet 110 generally comprises a sheet body 116 formed to have an angled top surface 118 having a first vertical sheet surface 120 and a second vertical sheet surface 122. Angled top surface 118 generally comprises a perforated top portion 124. First vertical sheet surface 120 comprises a front opening 126, a fastening aperture 127 and a plurality of front mounting feet 128. Second vertical support surface comprises a plurality of rear mounting feet 130 and at least one retention tab 132. First vertical sheet surface 120 has a first vertical height 134 while second vertical sheet surface 122 has a second vertical height 136. Generally, first vertical height 134 exceeds second vertical height 136 such that angled top surface 118 resides at an angle a relative to a plane defined by front mounting feet 128 and rear mounting feet 130. In one representative embodiment, α is about 15°. Front mounting feet 128 and rear mounting feet 130 each comprise a mounting bore 138.

Referring to FIGS. 8 and 9, vertical support member 112 generally comprises a support body 140 formed to have a first vertical support surface 142 and a second vertical support surface 144 arranged in a generally transverse orientation. First vertical support surface 142 generally comprises an angled surface 145. Second vertical support surface 144 generally comprises a plurality of support bores 146. Vertical support member 112 can be attached to mounting sheet 110 as illustrated in FIG. 1 using a suitable joining procedure such as, for example, by welding the vertical support member 112 to mounting sheet 110.

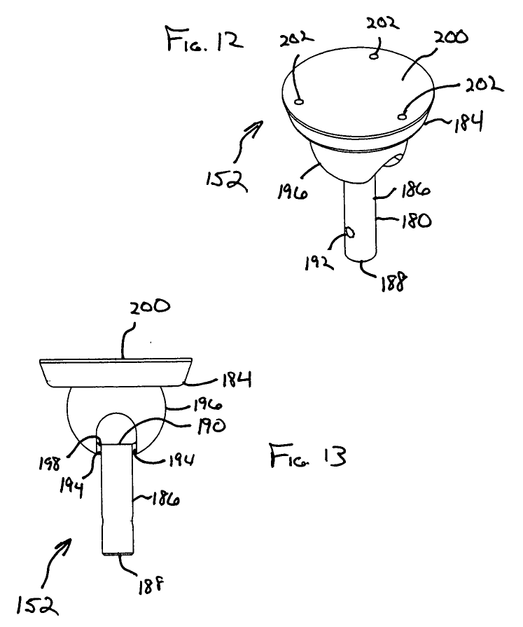

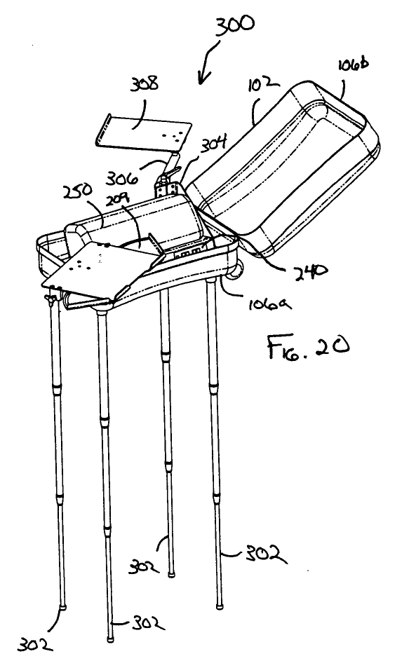

Referring to FIGS. 10, 11, 12, 13, 14, 15 and 16, peripheral support assembly 114 generally comprises a rotatable arm assembly 150, a pivoting base assembly 152 and a peripheral support assembly 154.

As illustrate in FIG. 1, rotatable arm assembly 150 generally comprises a hinge assembly 156 and an arm member 158. Hinge assembly 156 generally comprises a hinge member 160 and a locking member 162. Arm member 158 generally comprises a cylindrical arm body 164 having a hinge mounting end 166 and a support mounting end 168 as shown in FIGS. 10 and 11. In some embodiments, cylindrical arm body 164 can include a tapered portion 170 intended to provide an increased diameter at hinge mounting end 166 increasing strength a the hinge mounting end 166. Hinge mounting end can include a mounting portion 172 having a mounting face 174 with a plurality of hinge mounting bores 176. Hinge assembly 156 allows arm member 158 to rotate up to about 180 degrees about an axis y₁. Locking member 162 can then be tightened to prevent further rotation when arm member 158 reaches a desired position. Support mounting end 168 can comprise a support mounting bore 178. In some embodiments, cylindrical body 164 can comprise a telescoping assembly allowing the distance between hinge mounting end 166 and support mounting end 168 to be slidably adjusted.

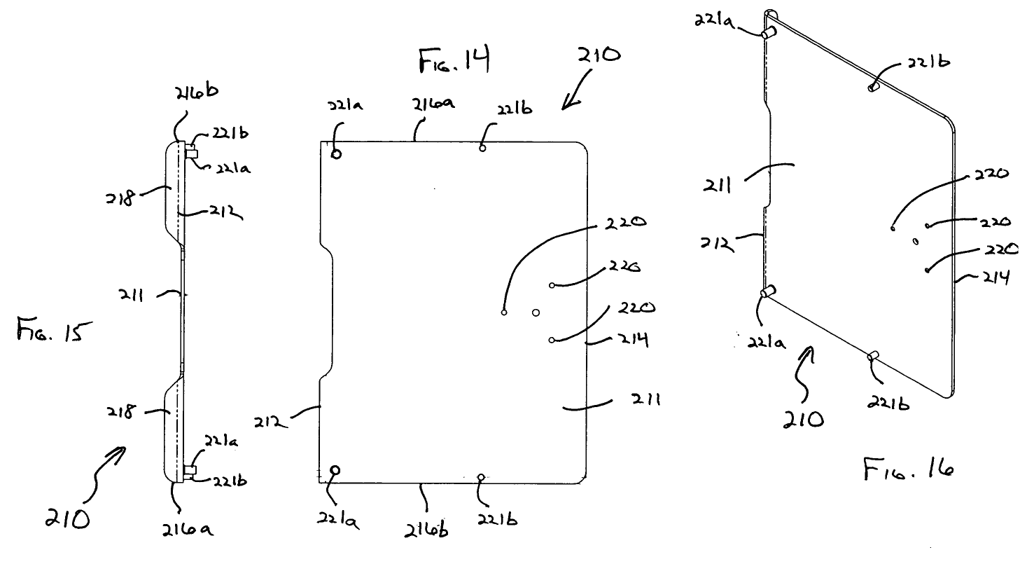

An embodiment of pivoting base assembly 152 is illustrated generally in FIGS. 12 and 13. Pivoting base assembly 152 generally comprises a support arm 180 and a pivot base 184. Support arm 180 generally comprises a cylindrical support body 186 having an insertion end 188 and a pivot mounting end 190. Cylindrical support body 186 includes a locking bore 192. Pivot mounting end 190 includes a pivot bore 194. Pivot base 184 generally comprises a pivot body 196, a pivot pin 198 and a pivot mounting surface 200. Pivot mounting surface 200 comprise a plurality of pivot mounting bores 202. In some embodiments, pivot base 184 can comprise an integral assembly commercially available from Panavise Products, Inc. of Reno, Nev. Pivoting base assembly 152 generally provides for adjustment around a vertical axis y₂ and a horizontal axis x as shown in FIG. 1.

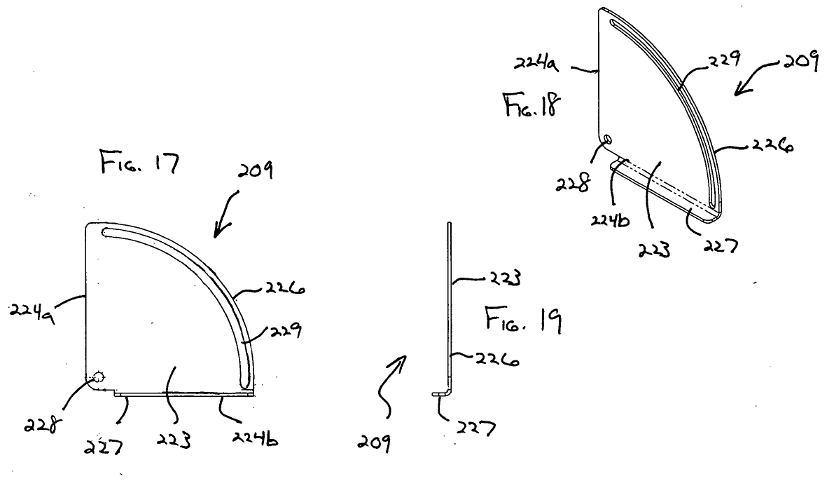

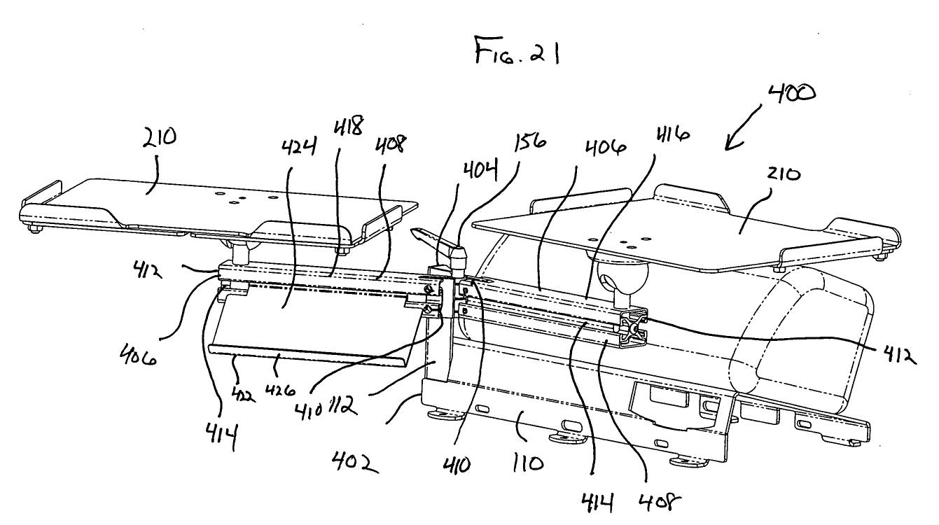

As illustrated in FIGS. 14, 15, 16, 17, 18 and 19, peripheral support sheet 154 can comprise a first support sheet 210 and one or more accessory support sheets 209. First support sheet 210 generally comprises a flat sheet body 211 having a sheet front portion 212, a sheet rear portion 214 and a pair of sheet side portions 216a, 216b. Sheet front portion 212 can comprise one or more front retaining members 218 that are formed so as to be generally transverse to a plane defined by flat sheet 210. Proximate the sheet rear portion 214, a plurality of sheet pivot bores 220 are arranged so as to conform to the arrangement of pivot mounting bores 202 on pivot mounting surface 200. Bottom side of first support sheet 210 can include a mounting stud 221a as well as a travel stud 221b. A plurality of sheet side bores 222 are located proximate the sheet side portions 216a, 216b. Accessory support sheet 212 can comprise an accessory sheet body 223 having a pair of generally transverse accessory sheet sides 224a, 224b connected with an arcuate accessory sheet side 226. Either of accessory sheet sides 224a, 224b can include an accessory sheet stop 227 formed so as to be generally transverse a plane defined by accessory sheet body 223. Accessory support sheet 212 can include one or more accessory sheet bores 228 and an arcuate travel aperture 229.

Referring again to FIGS. 1, 2, 3 and 4, portable workstation 100 can be generally assembled by first attaching mounting sheet 110 to a floor of the base portion 106a. Generally, a suitable fastener such as, for example, a screw, rivet or the like can be fixed to the base portion 106a such that mounting bores 138 can be slidingly placed over the fastener and suitably coupled with nut, clip or similar device. Alternatively, fasteners can be positioned through the mounting bores 138 and threaded into corresponding bores in the base portion 106a. With mounting sheet 110 attached to the base portion 106a, a variety of electrical components can be attached to or otherwise installed to simply connections to peripheral devices. For example, a power strip 240, as shown in subsequently described FIGS. 20 and 22, can be attached within front opening 126 to provide electrical connections for the various peripheral components. In addition, various components including for example, a power cord, battery or an inverter for allowing operation within a car can be attached to mounting sheet 110 to provide various power supply options to portable workstation 100. In order to accommodate and maintain the wiring associated with power strip 240, the inverter and the myriad of peripheral components that can be utilized with portable workstation 100, the various power cords can be constrained by a cable management assembly. The cable management assembly can comprise any of a variety of suitable devices for maintaining operable connection of the various power cords. For instance, the cable management assembly can comprise a flexible conduit, a plurality of wire ties and like devices. In some embodiments, portable workstation 100 can include a rechargeable battery allowing for use in locations absent a convenient power supply.

Peripheral support assembly 114 is generally assembled by mounting hinge member 160 between the vertical support member 112 and arm member 158. Using suitable fasteners, hinge member 160 is attached to support bores 146 on second vertical support surface 144 as well as to hinge mounting bores 176 on the mounting face 174. Insertion end 188 of support arm 180 is slidingly inserted through the support mounting bore 178 on the support mounting end 168 of the arm member 158. First support sheet 210 can be positioned such that sheet pivot bores 220 are aligned with the pivot mounting bores 200 on pivot mounting surface 200. Suitable fasteners can then be inserted through sheet pivot bores 220 and pivot mounting surface 200 so as to fixedly attach the first support sheet 210 to the pivot base 184. Accessory support sheet 209 can be rotatably attached to first support sheet 210 through the connection of mounting stud 221a and accessory sheet bore 228 as well as the insertion of travel stud 221b into arcuate travel aperture 229.

With peripheral mounting frame 104 assembled and mounted within base portion 106a, the various peripheral components can be operably connected and positioned with respect to the peripheral mounting frame 104. Generally, mounting sheet 110 is intended to accommodate mounting of a printer 250 as illustrated in FIGS. 1, 2, 3 and 4. Printer 250 can be selected from any of a variety of commercially available printers including, for example, bubble-jet and laser printers and may incorporate additional features including fax and scanning capabilities as are typically associated with “all-in-one” printers. Printer 250 can include models from companies such as Lexmark, Hewlett Packard, Canon and Epson. Printer 250 is generally positioned on sheet body 116 such that a rear portion of the printer 250 is retained by the at least one retention tab 132. Printer 250 can reside over perforated top portion 124 such that air can recirculate below printer 250 to remove heat and cool the printer 250. In some embodiments, additional holding assemblies can be used to retain printer 250 on mounting sheet 110 including, for example, restraining straps, hook and loop fasteners, snaps, ties, screws, bolts, molding, adhesive, wing nuts, and other such mounting means.

Peripheral support assembly 114 is generally configured to retain and position two or more peripheral items. Typically, a first peripheral item can include a conventional laptop computer mounted on first support sheet 210. Generally, a front portion of the first peripheral item is positioned along sheet front portion 212 such that the one or more front retaining members 218 prevent the first peripheral item from sliding forward off of the first support sheet 210. In addition to conventional laptop computers, the first peripheral item can include other microprocessor-based systems, such as, for example, a notebook, a tablet computer, handheld computer, PDA, and other such processing units. In some embodiments, the first peripheral item can include wireless networking capabilities for accessing the internet using available wireless networks. The first peripheral item can be temporarily mounted to first support sheet 210 using any suitable mounting means, such as, for example, restraining straps, hook and loop fasteners, snaps, ties, screws, bolts, molding, adhesive, wing nuts, and other such mounting means.

With the first peripheral item positioned on first support sheet 210, one or more accessory support sheets 209 can be rotated out from underneath first support sheet 210 for positioning and utilizing an accessory item. In one embodiment, the accessory item can include a computer mouse such that the accessory sheet body 223 provides a surface for manipulating a cursor on the first peripheral item. Depending on the user, either the accessory support sheet 209 corresponding to left or right handed usage can be rotated to a usable disposition based upon the particular user. With the accessory support sheet 209 rotated from beneath the first support sheet 210, the accessory sheet stop 227 can serve to prevent the second peripheral item from falling off of accessory support sheet 209 when released by a user.

With the first peripheral item mounted on first support sheet 210, the user can orient and position the first peripheral item into an optimal use position based upon the comfort and convenience of the user. Generally, the user can first unlock the locking member 162 such that arm member 158 can be rotated about the hinge assembly 156 and axis y₁. The user rotates the arm member 158 until a desired position is achieved. Arm member 158 can be rotated such that first support sheet 210 lies substantially outside the perimeter of protective case 102 providing access to both the first peripheral item and printer 250. The user can then grasp the first support sheet 210 and pivot the orientation of first support sheet 210 around the pivot base 184 and axis x. In addition, the user can rotate the orientation of first support sheet 210 by turning the first support sheet 210 such that the support arm 180 rotates within support mounting bore 178 and around axis y₂. As discussed previously, arm member 158 and support arm 180 can each including a telescoping design allowing for further positioning options. With printer 250 as well as the first and second peripheral items attached to the peripheral mounting frame 104, the various power components and communication cables can be organized with the cable management assembly and plugged into power strip 240. Alternatively, the first peripheral item, second peripheral item and/or printer 250 can be adapted for wireless communication so as reduce or eliminate necessary cabling between components as well as providing access to e-mail, the Internet and phone lines allowing for the use of scanning and/or facsimile capabilities.

As described, portable workstation 100 can be packed and configured for portable use, such as in a vehicle. When packed and enclosed within protective case 102, a fastening strap such as, for example, a strap having a hook and loop fastener assembly can be wrapped from underneath mounting sheet 110, through fastening aperture 127 and fully around the peripheral mounting frame 104, such that the fastening strap can be engaged and provide support and retention during transport. Referring to FIG. 2, at a time of use, the fastening strap can be removed such that first support sheet 210 is rotated so as to be located outside of protective case 102. Preferably, first support sheet 210 is rotated outside the perimeter of protective case 102 such that there is no physical interference between the first peripheral item and the computer 250. Protective case 102 can be secured to the passenger seat of a vehicle, for example, by means of a seatbelt, bolt, ties, and other suitable securing devices.

In another representative embodiment of a portable workstation 300 as illustrated in FIG. 20, additional functionality can be added. Generally portable workstation 300 can substantially resemble portable workstation 100 with the addition of a plurality of telescoping legs 302 integrated into base portion 106a as well as a second vertical support member 304 and a second peripheral support assembly 306. Generally, three or more telescoping legs 302 are mounted to the bottom of base portion 106a such that they can selectively extended so as make the portable workstation 300 self supporting. This self supporting functionality can be especially advantageous in situations where a table, desk, or other structure is unavailable for placement of the portable workstation 300.

Second vertical support member 304 and second peripheral support assembly 306 can substantially resemble the look and construction of vertical support member 112 and peripheral support assembly 114. Second peripheral support assembly 306 can rotatably and pivotally support a second support sheet 308 that resembles first support sheet 210. Preferably, the combination of second vertical support member 304 and second peripheral support assembly 306 can support the second support sheet 308 at a differing height, either higher or lower than first support sheet 210, such that both the first support sheet 210 and second support sheet 308 can be inwardly rotated into a perimeter defined by the protective case 102 without interfering with one another during transport and storage of the portable workstation 100. In one preferred embodiment, second support sheet 308 can provide a surface upon which a second peripheral item can be mounted. In one presently contemplated embodiment, the second peripheral item can comprise a digital projector allowing images from the first peripheral item to be displayed on a wall or screen. Portable workstation 300 can be especially valuable for use as an integral presentation system for making sales presentations or displaying project information such as, for example, on a construction site without requiring the presentation site be equipped with audio/visual equipment. Furthermore, the self-supporting nature of portable workstation 300 allows the portable workstation 300 to function as a desk when a desk, table or other mounting surface is unavailable.

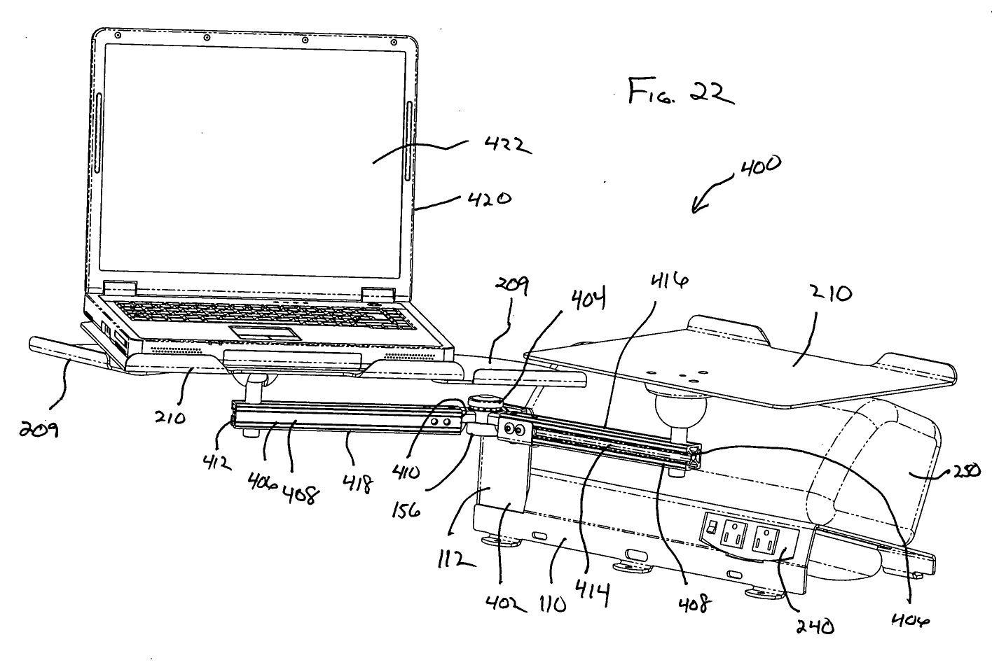

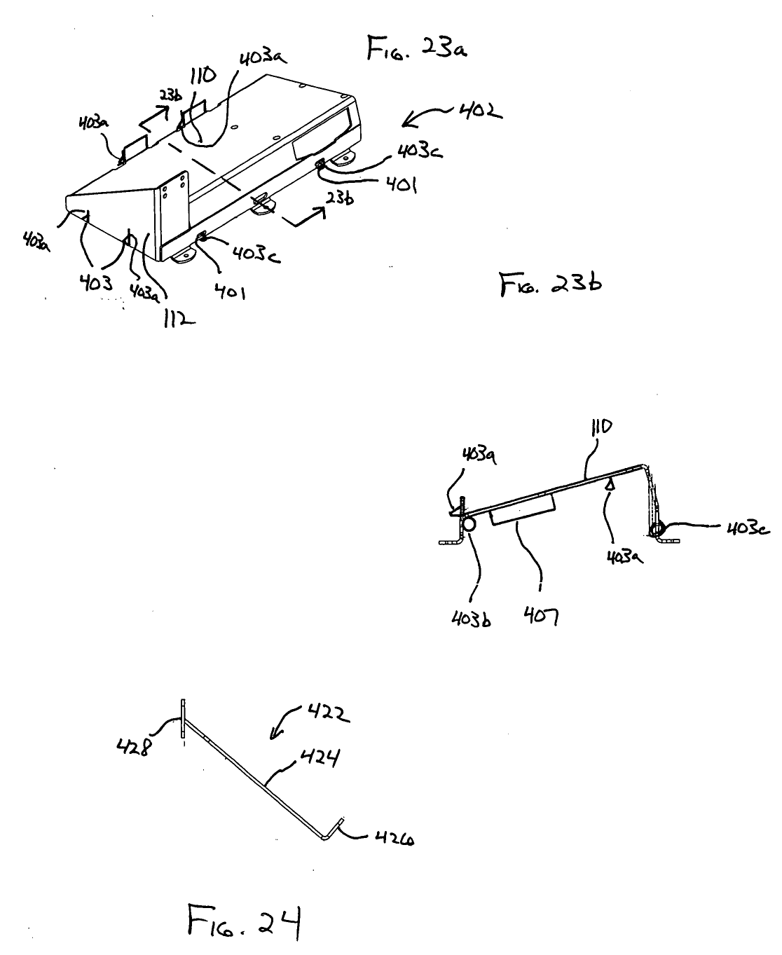

Referring to FIGS. 21, 22, 23a and 23b, another representative embodiment of a portable workstation 400 can substantially resemble the construction and appearance of portable workstation 100 and portable workstation 300 with the exception of a modified mounting frame 402. Generally, mounting frame 402 can include vertical support member 112 operably attached to mounting sheet 110 as shown in FIG. 23a. Modified mounting frame 402 can further include a plurality of retention apertures 401. Referring to FIG. 23b, mounting frame 102 can further include a cable management assembly 403 for controlling and maintaining the various power and communication cables necessary to maintain portable workstation 400 in ready-for-operation state. Cable management assembly 403 can comprise a variety of suitable components including, for example, wire clips 403a, flexible conduit 403b, wire ties 403c for engagement with retention aperture 401 and the like. Mounting frame 102 can further include a bottom mounted power cord spool 407 providing the portable workstation 400 with a plug connection to a local power source. Peripheral support assembly 404 can substantially resemble peripheral support assembly 114 with the exception of rotatable arm assembly 150 being replaced with channel arm assembly 406. Channel arm assembly 406 generally comprises hinge assembly 156 and channel arm member 408. Channel arm member 408 includes an channel arm hinge mounting end 410 and an channel arm support mounting end 412. An arm channel 414 can be defined along the length of channel arm member 408 between the channel arm hinge mounting end 410 and the channel arm support mounting end 412.

Generally, portable workstation 400 can be used in a similar manner as previously described with portable workstation 100. As seen in FIGS. 21 and 22, the channel arm member 408 can be rotated about hinge assembly 156 such that first support sheet 210 is moved between a non-use disposition 416 and a usable disposition 418 in which a first peripheral 420 shown as laptop computer 422 can be utilized.

Channel arm assembly 408 further provides the opportunity to attach a slidable support sheet 422 shown in FIG. 24 to the channel arm assembly 406. Slidable support sheet 422 generally comprises a slidable support sheet body 424 having a front retaining lip 426 and a flanged slide member 428. Flanged slide member 428 is slidably insertable into the arm channel 414 at channel arm support mounting end 412 such that the slidably support sheet 422 can be releasably attached to the channel arm member 408 when positioned in the usable disposition 418. With slidable support sheet 422 attached to the channel arm member 408, items such as handwritten notes, references such as magazines and newspapers and writing instruments such as pens and pencils can be placed on slidable support sheet body 424 and retained by front retaining lip 426 as a user utilizes the laptop computer 422. When use of portable workstation 400 is complete, the user slidably removes the slidable support sheet 422 from the arm channel 414, wherein the first support sheet 210 can be rotated to the non-use disposition 416.

While the present invention has been described with respect to a variety of representative, presently contemplated embodiments, it will be understood that numerous insubstantial changes in configuration, arrangement or appearance of the elements of the present invention can be made without departing from the intended scope of the present invention.

1. A portable workstation comprising:
a protective case having a base portion and a lid portion defining an internal storage area;
a peripheral mounting frame attached to the base portion, the peripheral mounting frame having a mounting sheet, a vertical support and a first peripheral support assembly, wherein the first peripheral support assembly includes a rotatable arm assembly and a pivoting mounting surface;
a printer attached to the peripheral mounting frame; and
a first peripheral device attached to the pivoting mounting surface such that the first peripheral device is rotatably movable with the rotatable arm assembly between a non-use disposition and a use disposition and the first peripheral device is pivotally movable to an optimal use position.

2. The portable workstation of claim 1, further comprising:
a power component attached to the peripheral mounting frame, the power component operably connected to the printer and the first peripheral device wherein the power component is selected from the group consisting essentially of: a battery, an inverter and a power cable.

3. The portable workstation of claim 1, further comprising a cable management assembly for managing power and communication cables between the printer and the first peripheral device, the cable management assembly including cable management components selected from the group consisting essentially of: a flexible conduit, a wire clip, a wire tie and combinations thereof.

4. The portable workstation of claim 1, wherein the combination of the rotatable arm assembly and a pivoting mounting surface provide three degrees of freedom for orienting the first peripheral device in a desired orientation.

5. The portable workstation of claim 1, wherein the rotatable arm assembly includes a locking hinge assembly for selectively loosening and locking the rotatable arm assembly.

6. The portable workstation of claim 5, wherein the first peripheral support assembly can be configured for either left-handed or right-handed adjustment.

7. The portable workstation of claim 1, wherein the first peripheral support assembly further comprises at least one accessory surface rotatably mounted to an underside of the pivoting mounting surface such that the at least one accessory surface can be rotatably positioned relative to the first peripheral device so as to allow use of an accessory device with the laptop computer.

8. The portable workstation of claim 7, wherein the accessory device is a computer mouse.

9. The portable workstation of claim 1, wherein the first peripheral device is selected from the group consisting essentially of: a laptop computer, a tablet computer, a handheld computer, a Personal Digital Assistant, a cellphone and a multimedia device.

10. The portable workstation of claim 1, further comprising:
a second peripheral support assembly rotatably attached to the peripheral mounting frame, the second peripheral support assembly having a second peripheral support sheet for mounting a second peripheral device.

11. The portable workstation of claim 10, wherein the second peripheral device comprises a digital projector.

12. The portable workstation of claim 1, wherein the base portion comprises at least three telescoping legs so as to form a self-supporting protective case.

13. The portable workstation of claim 1, wherein the protective case comprises an item of carry-on luggage.

14. A method for providing a mobile workstation comprising:
providing a protective container having a mounting frame attached within;
attaching a printer to the mounting frame;
coupling a first peripheral support assembly to the mounting frame, the first peripheral support assembly having a rotatable arm assembly and a pivoting mounting surface for receiving a laptop computer;
adjusting the rotatable arm assembly and pivoting mounting surface through three degrees of freedom such that the laptop computer is positioned for use; and
maintaining operable interconnection of the laptop computer and printer with a cable management assembly.

15. The method of claim 14, further comprising:
coupling a second peripheral support assembly to the mounting frame, the second peripheral support assembly having a second mounting surface for receiving a digital projector.

16. The method of claim 14, further comprising:
extending a plurality of projecting legs from a bottom surface of the protective carrier so as to selectively adjust the height of the protective carrier.

17. The method of claim 14, further comprising:
positioning at least one accessory support surface attached to the pivoting mounting surface such that an accessory device can be utilized with the laptop computer.

18. The method of claim 14, further comprising:
transporting the protective carrier in a closed configuration with the laptop computer and printer operably connected.

19. The method of claim 18, further comprising:
placing the protective carrier arranged in the closed configuration within an overhead bin on an airplane.
